(19) United States
(12) Patent Application Publication
(10) Pub. No.: US 2015/0380841 A1
(43) Pub. Date: Dec. 31, 2015

(54) Fuse Block

(71) Applicant: YAZAKI CORPORATION, Tokyo (JP)

(72) Inventors: Tsuyoshi Toratani, Shizuoka (JP); Hiromichi Inoue, Shizuoka (JP); Mitsuji Kubota, Shizuoka (JP)

(21) Appl. No.: 14/847,427

(22) Filed: Sep. 8, 2015

Related U.S. Application Data
(63) Continuation of application No. PCT/JP2014/056146, filed on Mar. 10, 2014.

(30) Foreign Application Priority Data
Mar. 15, 2013 (JP) 2013-052637

(51) Int. Cl. H01R 9/24; H01H 85/20

(52) U.S. Cl. CPC H01R 9/245; H01H 85/2045

(57) ABSTRACT

When a first terminal and a second terminal are respectively attached to a terminal holder and held, a board connection part and a second board connection part are inserted into a prescribed through hole of a circuit board under a state that the board connection part and the second board connection part are superposed one upon another and put together. Further, after that, a soldering operation is carried out, an electric connection of the first terminal and the second terminal and an electric connection to the circuit board are completed.

### CROSS REFERENCE TO RELATED APPLICATIONS

This application is a continuation of PCT application No. PCT/JP2014/056146, which was filed on Mar. 10, 2014 based on Japanese Patent Application (No. 2013-052637) filed on Mar. 15, 2013, the contents of which are incorporated herein by reference.

### BACKGROUND OF THE INVENTION

1. Field of the Invention

The present invention relates to a fuse block.

2. Description of the Related Art

As an electric device mounted on a vehicle such as a motor vehicle, for instance, an electric junction box is exemplified. The electric junction box is known as a general name given to a relay box or a fuse box, or a junction block or an electronic control unit box or the like.

In an electric junction box disclosed in blow-described patent literature 1, a plurality of loads is connected to a downstream side through a wire harness. The electric junction box has a formation and a structure which distribute an electric power to the plurality of loads. Now, the electric junction box of the patent literature 1 will be described below.

As shown in FIG. 7, is illustrated the electric junction box 101 under a state that a cover member is omitted. The electric junction box 101 includes a circuit board 102, an electronic component 103, connectors 104 and 105 (connector blocks), a fuse block 106, an ECU connection connector 107 and other component members.

On the circuit board 102, the electronic component 103 is mounted. Further, to the circuit board 102, the connectors 104 and 105, the fuse block 106 and the ECU connection connector 107 are also attached. The electronic component 103, the connectors 104 and 105, the fuse block 106 and the ECU connection connector 107 are electrically connected to prescribed positions of a circuit pattern formed on the circuit board 102. The electronic component 103 is a plurality of switching transistors 108 or an integrated circuit 109 which are respectively electrically connected respectively through connection parts of their terminals.

The connector 104 includes a connector housing 110 and a plurality of L shaped terminals 111. The connector housing 110 is a resin component and includes a housing main body 112 to which a mate connector which is not shown in the drawing is fitted and a housing fixing part screwed to the circuit board 102. The L shaped terminals 111 have one end parts which are enclosed by the housing main body 112 and arranged so as to be electrically connected to the mate side connector which is not shown in the drawing. Further, the other ends of the L shaped terminals 111 are inserted into through holes of the circuit board 102 and soldered to the prescribed circuit pattern.

The connector 105 is formed in the same way as the above-described connector 104. Namely, the connector 105 includes a connector housing 113 and a plurality of L shaped terminals 114. The connector housing 113 is a resin component and includes a housing main body 115 to which a mate connector which is not shown in the drawing is fitted and a housing fixing part screwed to the circuit board 102. The L shaped terminals 114 have one end parts which are enclosed by the housing main body 115 and arranged so as to be electrically connected to the mate side connector which is not shown in the drawing. Further, the other ends of the L shaped terminals 114 are inserted into through holes of the circuit board 102 and soldered to the prescribed circuit pattern.

As shown in FIG. 7 and FIG. 8, the fuse block 106 is a part on which blade type fuses are mounted and includes a fuse cover 116, a terminal holder 117 and a laminar terminal group 118. The fuse cover 116 and the terminal holder 117 are structure bodies made of a resin and have an insulating property. Further, the laminar terminal group 118 is formed in such a way that terminal groups 119 to 122 are arranged in the states of a plurality of layers and has an electrical conductivity.

The fuse cover 116 has fuse mounting parts 123 and 124, a housing 125, a connector housing 126 and an engagement arm 127. The fuse mounting part 123 is formed so as to be arranged on the fuse mounting part 124. In the left side of the fuse mounting part 123, the housing 125 and the connector housing 126 are arranged and formed. In the right side of the fuse mounting parts 123 and 124, the engagement arm 127 is arranged and formed.

The fuse mounting parts 123 and 124 respectively have a plurality of fuse cavities 128. The plurality of fuse cavities 128 are formed so as to be arranged in a transverse direction. The fuse cavity 128 is formed in such a way that the blade type fuse is pushed in from a forward direction to a rearward direction therein. The fuse mounting parts 123 and 124 are arranged in upper and lower sides. The housing 125 is formed as a mounting part of a fusible link. Further, the connector housing 126 is formed as a connection part for a main power source and an alternator power source.

The terminal holder 117 is formed so that the terminal holder may hold the terminal groups 119 to 122 forming the laminar terminal group 118. In a side part of the terminal holder 117, an engagement protrusion 129 is formed with which the engagement arm 127 of the fuse cover 116 is engaged.

The laminar terminal group 118 includes the plurality of terminal groups 119 to 122 as described above. In explaining the terminal groups in order from a lower layer to an upper layer, the terminal group 119 is arranged in the first layer, the terminal group 120 is arranged in the second layer, the terminal group 121 is arranged in the third layer and the terminal group 122 is arranged in the fourth group.

The terminal group 119 serving as the first layer has a plurality of L shaped terminals 130. The plurality of L shaped terminals 130 are formed so as to be arranged in the transverse direction. Further, the terminal group 119 has a power input terminal part 131 in addition thereto. In one end of the L shaped terminal 130, a tuning fork shaped terminal part 132 is formed. Further, in the other end of the L shaped terminal 130, a board connection part 133 is formed.

The terminal group 120 serving as the second layer has a plurality of L shaped terminals 134. The plurality of L shaped terminals 134 are formed so as to be arranged in the transverse direction. Further, the terminal group 120 has a power input terminal part 135 in addition thereto. In one end of the L shaped terminal 134, a tuning fork shaped terminal part 136 is formed. Further, in the other end of the L shaped terminal 134, a board connection part 137 is formed.

The terminal group 121 serving as the third layer has a plurality of L shaped terminals 138. The plurality of L shaped terminals 138 are formed so as to be arranged in the transverse direction. Further, the terminal group 121 has a terminal part 139 for the fusible link in addition thereto. Further, in one end of the L shaped terminal 138, a tuning fork shaped terminal part 140 is formed. Further, in the other end of the L shaped terminal 138, a board connection part 141 is formed.

The terminal group 122 serving as the fourth layer has a plurality of L shaped terminals 142. The plurality of L shaped terminals 142 are formed so as to be arranged in the transverse direction. Further, the terminal group 122 has a terminal part 143 for the fusible link in addition thereto. Further, in one end of the L shaped terminal 142, a tuning fork shaped terminal part 144 is formed. Further, in the other end of the L shaped terminal 142, a board connection part 145 is formed.

In the plurality of L shaped terminals 130, 134, 138 and 142, intermediate parts of them are respectively accommodated in the terminal holder 117. Then, after that, when the fuse cover 116 is engaged with the terminal holder 117, the tuning fork shaped terminal parts 132, 136, 140 and 144 are respectively accommodated and held in the cavities 128 corresponding thereto.

[Patent Literature 1] JP-A-2006-333583

### SUMMARY OF THE INVENTION

In the fuse block 106 in the above-described usual technique, since the terminal groups 119 and 120 are included in the structure which have the tuning fork shaped terminal parts 132 and 136 and the power input terminal parts 131 and 135, the fuse block 106 has such problems as described below.

Namely, since the tuning fork shaped terminal parts 132 and 136 require resilience as parts which sandwich fuse terminals of the blade type fuses, a material more expensive than an ordinary terminal material needs to be used. Accordingly, in a terminal form, when the power input terminal parts 131 and 135 are integrally formed in an arrangement as shown in the drawing, a problem arises that a yield is deteriorated during a production of the terminal, so that the fuse block 106 of a high cost is manufactured.

The present invention is devised by considering the above-described circumstances, and it is an object to provide a fuse block which can improve a yield during a production of a terminal so that a cost may be lowered.

The above-described object of the present invention is achieved by below-described structures.

(1) A fuse block includes a first terminal having one or a plurality of tuning fork shaped terminal parts formed in one end and one or a plurality of first board connection parts formed in the other end and a second terminal having a power input terminal part formed in one end and second board connection parts formed in the other end with the number corresponding to the number of the first board connection parts. Further, the second board connection parts are inserted into through holes to which the first board connection parts are inserted and electrically connected together therewith.

According to the fuse block having the structure of the above-described (1), the first terminal having the tuning fork shaped terminal parts and the second terminal having the power input terminal part are manufactured so as to be divided, so that the tuning fork shaped terminal parts and the power input terminal part are provided not to be mixed in the same terminal in the structure. After the first terminal and the second terminal are manufactured so as to be divided, the first board connection parts and the second board connection parts are inserted into the same through holes and electrically connected.

Namely, for the terminals forming the fuse block, a yield during the production of the terminal can be more improved than that in the usual fuse block. Accordingly, a cost can be reduced.

(2) In a fuse block including the structure of the above-described (1), the first board connection parts and the second board connection parts which are connected together are superposed one upon another and parts continuous thereto are also superposed thereon.

According to the fuse block having the structure of the above-described (2), not only the first board connection parts and the second board connection parts, but also the parts continuous thereto are also superposed thereon in the structure. Thus, an integral state of the first terminal and the second terminal is stabilized, so that an electrical connection state is also stabilized.

Namely, a superposed range can be increased. Thus, the integral state and the electrical connected state of the first terminal and the second terminal can be stabilized.

(3) In a fuse block including the structure of the above-described (1) or (2), the first terminal and the second terminal are formed with metal plates made of different materials.

According to the fuse block having the structure of the above-described (3), the first terminal having the tuning fork shaped terminal parts can be manufactured with a terminal material having resilience and the second terminal having the power input terminal part can be effectively manufactured with an ordinary and cheap terminal material.

Namely, the cheap terminal material can be partly used, which can contribute to the reduction of the cost.

The present invention is briefly described as mentioned above. Further, when mode for carrying out the invention (refer it to as an “embodiment”, hereinafter) which will be described below will be read by referring to the attached drawings, a detail of the present invention will be more clarified.

### BRIEF DESCRIPTION OF THE DRAWINGS

FIG. 1 is a perspective view showing a fuse block according to one embodiment of the present invention which is seen from an obliquely upper part.

FIG. 2 is a perspective view showing the fuse block shown in FIG. 1 which is seen from an obliquely lower part.

FIG. 3 is a perspective view of a first layer terminal group to a third layer terminal group shown in FIG. 1.

FIG. 4 is a perspective view of a first terminal and a second terminal shown in FIG. 3.

FIG. 5 is an enlarged perspective view of a part shown by A in FIG. 2.

FIG. 6 is a perspective view showing a state that a first board connection part of the first terminal and a second board connection part of the second terminal shown in FIG. 4 are inserted into the same through hole.

FIG. 7 is a perspective view showing an electric junction box of a usual example.

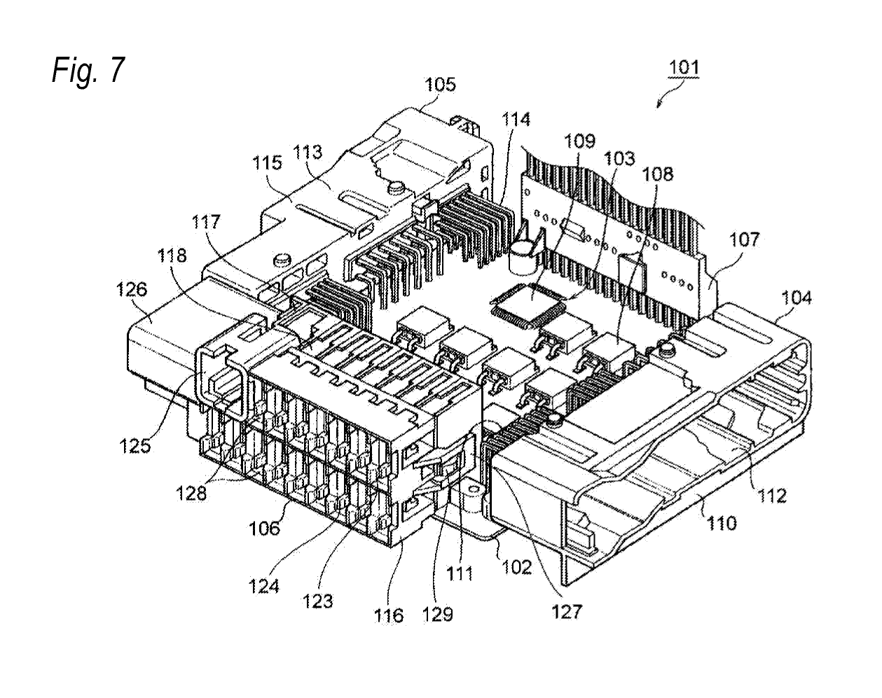

FIG. 8 is an exploded perspective view of a fuse block shown in FIG. 7.

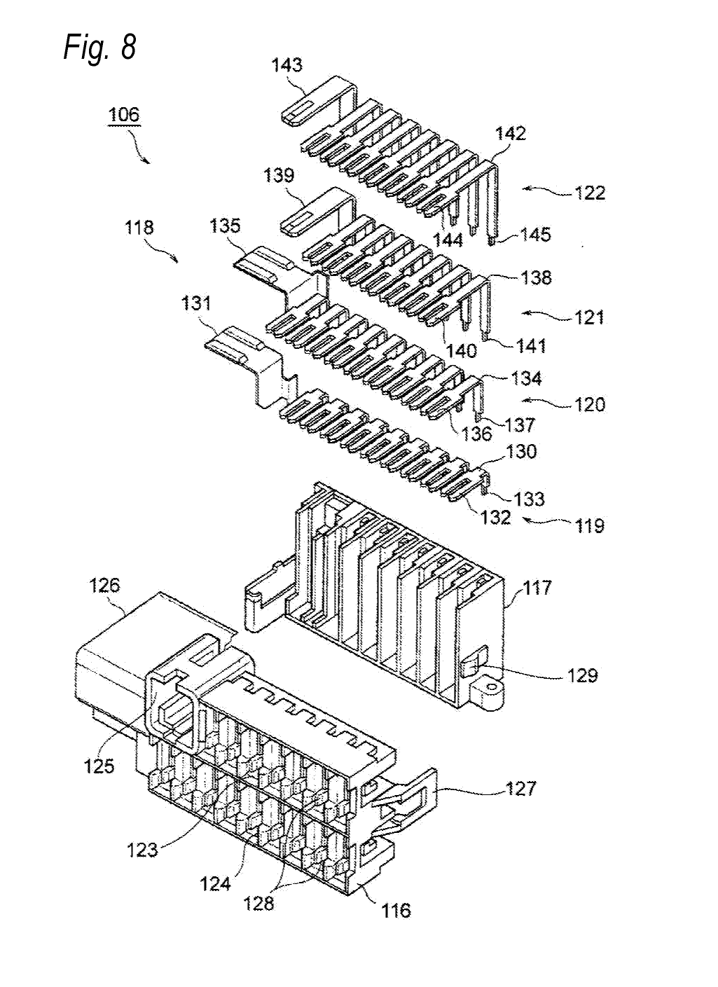

### DETAILED DESCRIPTION OF THE EXEMPLARY EMBODIMENTS

In a fuse block according to the present invention, as for a terminal forming the fuse block, a first terminal having tuning fork shaped terminal parts and a second terminal having a power input terminal part are divided and manufacture. Then, an electric connection of them is formed in such a way that first board connection parts formed in the first terminal and second board connection parts formed in the second terminal are inserted into the same through holes and soldered.

Now, one embodiment of the present invention will be described below by referring to the attached drawings.

In a below-described explanation, specific forms, materials, numeric values and directions are exemplified in order to easily understand the present invention and may be suitably changed depending on uses, purposes and specifications. Further, an electric junction box mounted on a motor vehicle is described as an example, however, the present invention may be adopted for, for instance, many kinds of and a variety of electric devices other than the electric junction box of the motor vehicle.

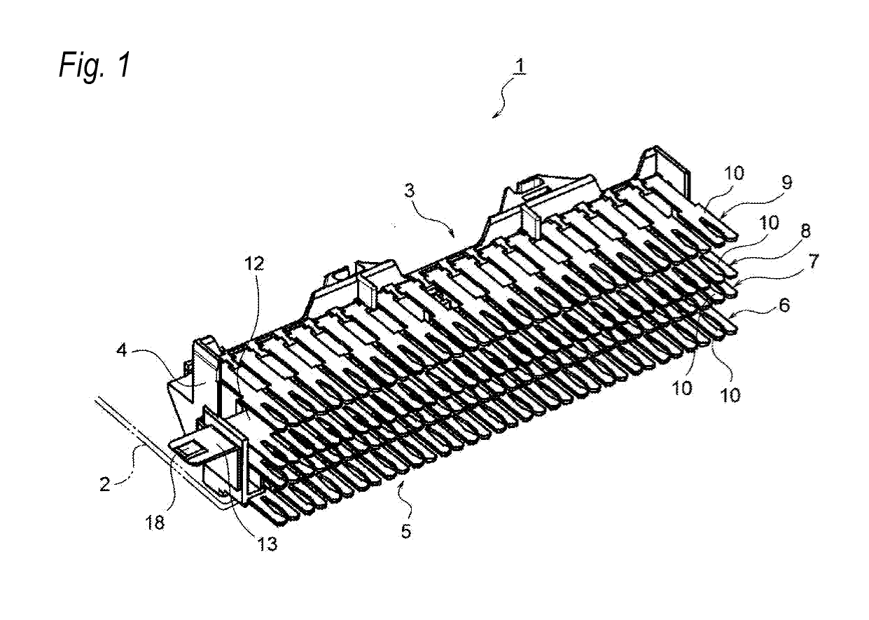

In FIG. 1, the electric junction box is formed to include a cover member not shown in the drawing and an electric junction box main body 1 accommodated in the cover member. Further, the electric junction box main body 1 is formed to include a circuit board 2 having a desired circuit pattern, board mounted components and a connector block which are mounted on prescribed positions of the circuit board 2 and are not shown in the drawing and a fuse block 3 which is likewise mounted on a prescribed position of the circuit board 2. Component members that are not shown in the drawing except the fuse block 3 are supposed to be the same as the usual component members and a detailed explanation thereof is omitted.

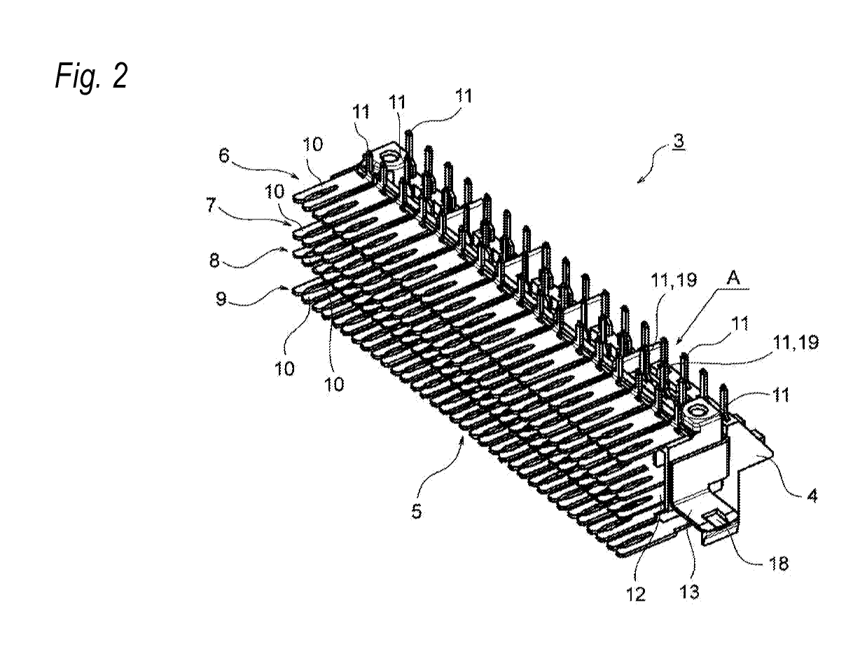

In FIG. 1 and FIG. 2, the fuse block 3 is a part on which blade type fuses not shown in the drawing are mounted and includes a fuse cover not shown in the drawing, a terminal holder 4 and a laminar terminal group 5. The fuse cover and the terminal holder 4 are structure bodies made of a resin and have an insulating property. Further, the laminar terminal group 5 is formed in such a way that terminal groups 6 to 9 are arranged in the states of a plurality of layers and has an electrical conductivity. (In the laminar terminal group 5 shown in the drawing, the terminal groups 6 to 9 are arranged in the states of four layers).

The terminal group 6 serving as the first layer has a plurality of the same kinds of L shaped terminals. Further, the terminal group 6 is formed in such a way that the plurality of L shaped terminals is arranged in the transverse direction. In one end of the L shaped terminal in the terminal group 6, a plate type tuning fork shaped terminal part 10 is formed which is substantially horizontal to the circuit board 2. Further, in the other end of the L shaped terminal, a pin shaped board connection part 11 is formed which is substantially vertical to the circuit board 2.

The terminal group 7 serving as the second layer has a plurality of kinds of L shaped terminals. Further, the terminal group 7 is formed in such a way that the plurality of L shaped terminals is arranged in the transverse direction. In one end of the L shaped terminal in the terminal group 7, a plate type tuning fork shaped terminal part 10 is formed which is substantially horizontal to the circuit board 2. Further, in the other end of the L shaped terminal, a pin shaped board connection part 11 is formed which is substantially vertical to the circuit board 2.

The terminal group 8 serving as the third layer has a plurality of kinds of L shaped terminals like the above-described terminal group 7. The terminal group 8 is formed in such a way that the plurality of L shaped terminals is arranged in the transverse direction. Further, in one end of the L shaped terminal in the terminal group 8, a plate type tuning fork shaped terminal part 10 is formed which is substantially horizontal to the circuit board 2. Further, in the other end of the L shaped terminal, a pin shaped board connection part 11 is formed which is substantially vertical to the circuit board 2. In the present embodiment, in the terminal group 8, a below-described power input terminal part 18 is included.

The terminal group 9 serving as the fourth layer has a plurality of the same kinds of L shaped terminals like the above-described terminal group 6. The terminal group 9 is formed in such a way that the plurality of L shaped terminals is arranged in the transverse direction. Further, in one end of the L shaped terminal in the terminal group 9, a plate type tuning fork shaped terminal part 10 is formed which is substantially horizontal to the circuit board 2. Further, in the other end of the L shaped terminal, a pin shaped board connection part 11 is formed which is substantially vertical to the circuit board 2.

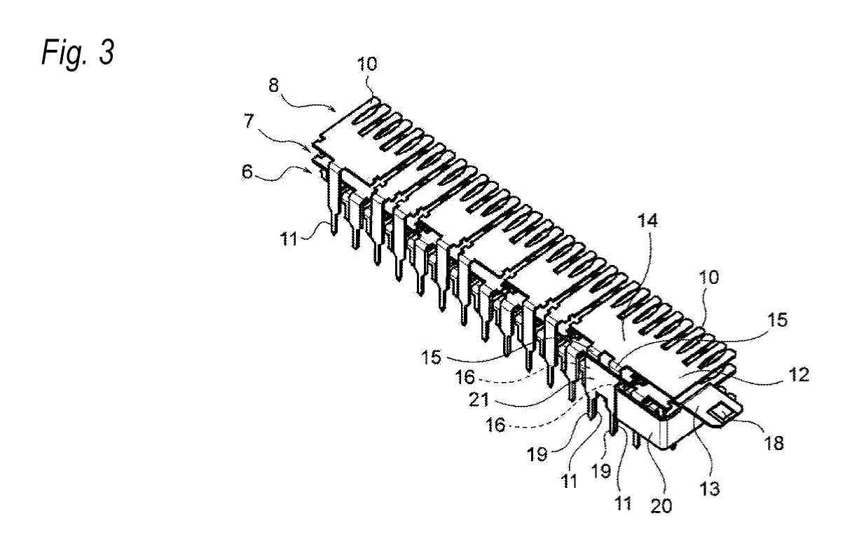

In FIG. 3, is shown the laminar terminal group 5 with the terminal group 9 (see FIG. 1) serving as the fourth layer omitted. The terminal group 9 is omitted, because, in the present embodiment, the terminal group 8 serving as the third layer has a feature of the present embodiment and accordingly, the featured part is shown so as to be easily understood. The featured part of the present embodiment is not limited to the terminal group 8 serving as the third layer. Namely, the featured part may be provided in other layer.

When the L shaped terminal in a first end of the L shaped terminals forming the terminal group 8 which is designated by reference numeral 12 is supposed to be a first terminal, a second terminal 13 is integrally formed with the first terminal 12. The second terminal 13 is held by the terminal holder 4 (see FIG. 2) and integrally formed with the first terminal 12 by a below-described electric connection.

As understood from a below-described explanation, since the first terminal 12 and the second terminal 13 are divided in a formation and a structure of the present embodiment, a yield during a production of the terminal can be more improved than that of the usual structure. Thus, a cost can be effectively reduced. Initially, the structures of the first terminal 12 and the second terminal 13 will be described.

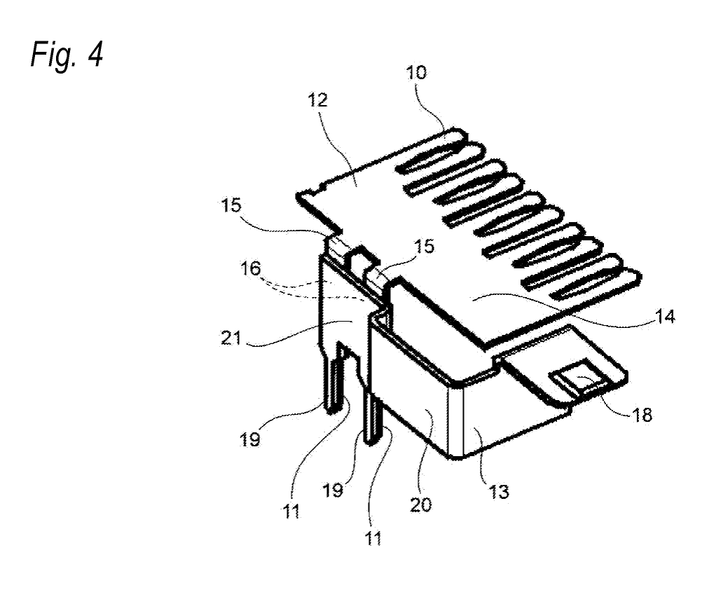

In FIG. 4, the first terminal 12 is the L shaped terminal as described above. In the one end of the L shaped terminal, the tuning fork shaped terminal parts 10 are formed. In the other end, the board connection parts 11 are formed. Further, in an intermediate part between the tuning fork shaped terminal parts 10 and the board connection parts 11, a horizontal plate part 14, bent parts 15 and vertical plate parts 16 are formed. The board connection part 11 corresponds to a first board connection part described in claims.

The tuning fork shaped terminal part 10 is formed so as to connect a fuse terminal of a fuse which is not shown in the drawing. Specifically, the tuning fork shaped terminal part is configured in the form of a tuning fork so that the fuse terminal may be held. In the present embodiment, the five tuning fork shaped terminal parts 10 are formed so as to be arranged in the transverse direction. Since the first terminal 12 has the tuning fork shaped terminal parts 10 which hold the fuse terminals, an entire part thereof is manufactured by working a metal plate having resilience.

The horizontal plate part 14 is formed as a plate shaped part substantially horizontal to the circuit board 2 (see FIG. 1). In such a horizontal plate part 14, the five tuning fork shaped terminal parts 10 are continuously formed so as to be arranged in the transverse direction. By the five tuning fork shaped terminal parts 10, the horizontal plate part 14 is configured in a substantially rectangular form in plan view. In the usual horizontal plate part, the power input terminal part is also continuously formed. However, in the present embodiment, it is understood that the power input terminal part is not formed in the horizontal plate part. Accordingly, when the metal plate having the resilience is worked, a deterioration of yield does not arise which is caused by the layout of the power input terminal part.

The bent part 15 is formed when the vertical plate part 16 is bent so as to be directed to the circuit board 2 (see FIG. 1). The bent part 15 is formed so as to be arranged between the horizontal plate part 14 and the vertical plate part 16.

The vertical plate part 16 is formed as a belt plate shaped part substantially vertical to the circuit board 2 (see FIG. 1). Further, the vertical plate part 16 is formed as a leg shaped part. In the present embodiment, the two vertical plate parts 16 are formed. On the vertical plate parts 16, a below-described superposed plate part 21 is superposed.

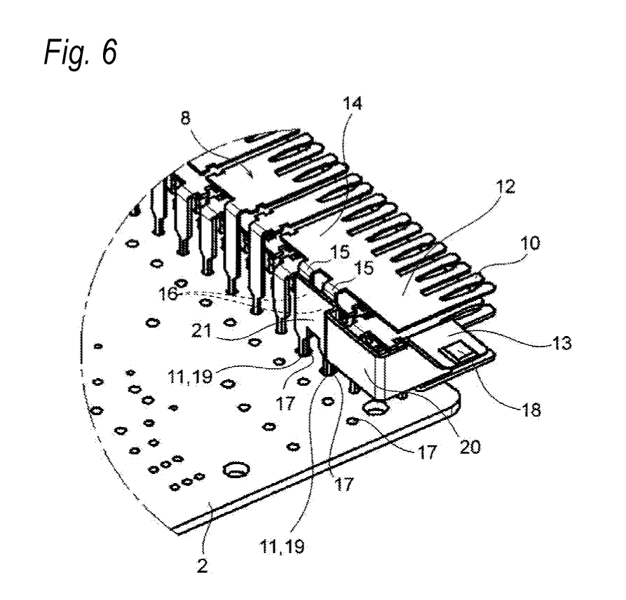

The board connection part 11 corresponds to the first board connection part described in claims as mentioned above and is formed so as to be inserted into a prescribed through hole 17 (see FIG. 6) of the circuit board 2 (see FIG. 1). Specifically, the board connection part is formed in a pin shaped part like a narrowed width of the vertical plate part 16.

On the board connection part 11, a below-described second board connection part 19 is superposed. In the present embodiment, the two board connection parts 11 are formed. The board connection parts 11 are arranged and formed in the same arrangement of the board connection parts 11 (see FIG. 3) of the terminal group 7 of the second layer.

The second terminal 13 is a part which does not require such resilience as that of the first terminal 12 and is manufactured by an ordinary and cheap terminal material. Namely, the material of the second terminal 13 is different from the material of the first terminal 12. In one end of the second terminal 13, the power input terminal part 18 is formed. In the other end, the second board connection parts 19 are formed. Further, in an intermediate part of the second terminal 13, a holding part 20 and the superposed plate part 21 are formed.

The power input terminal part 18 is formed as an input part of a power. Such a power input terminal part 18 is configured in the form of a tab. The power input terminal part 18 is arranged and formed so as to protrude in a direction different from the direction of the tuning fork shaped terminal part 10 of the first terminal 12.

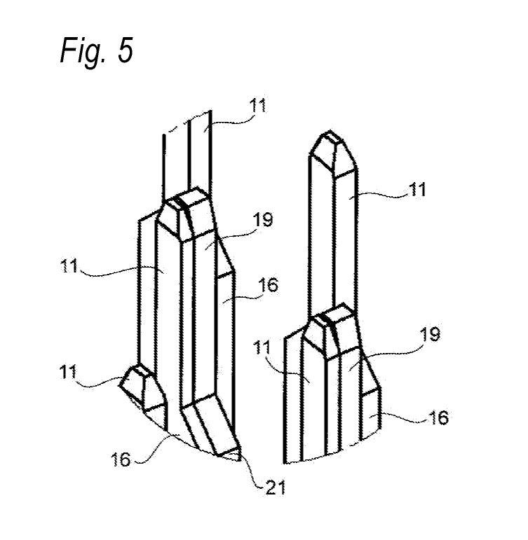

The second board connection part 19 is a part which is inserted into the prescribed through hole 17 (see FIG. 6) of the circuit board 2 (see FIG. 1) together with the board connection part 11 of the first terminal 12 and is configured in such a form (see FIG. 5) as to be superposed on the board connection part 11. Specifically, the second board connection part 19 is formed in a pin shaped part like the board connection part 11. In the present embodiment, the two second board connection parts 19 are formed and electrically connected together with the board connection parts 11 by soldering.

The holding part 20 and the superposed plate part 21 are formed as bus bar shaped parts which connect the power input terminal part 18 to the second board connection parts 19. The holding part 20 is configured in such a form as to be held when the second terminal is inserted into a prescribed position of the terminal holder 4 (see FIG. 2). On the other hand, the superposed plate part 21 is formed as a part superposed on the vertical plate parts 16 of the first terminal 12. In the superposed plate part 21, the second board connection parts 19 are continuously formed.

Under a state that the second terminal 13 is held by the terminal holder 4 (see FIG. 2), since the superposed plate part 21 is superposed on the vertical plate parts 16, a state that the second terminal 13 is formed integrally with the first terminal 12 is more stabilized. Further, a below-described electrically connected state is also stabilized.

Then, when the first terminal 12 and the second terminal 13 having the above-described structures are respectively attached to and held by the terminal holder 4 (see FIG. 2), the board connection parts 11 are superposed on the second board connection parts 19 to have a state as shown in FIG. 5. Then, under the superposed state, namely, under a state that the board connection parts 11 are formed together with the second board connection parts 19, they are inserted into the prescribed through holes 17 of the circuit board 2 as shown in FIG. 6. Further, after that, when a soldering operation is carried out, an electrical connection of the first terminal 12 and the second terminal 13 and an electrical connection to the circuit board 2 are completed.

As described above by referring to FIG. 1 to FIG. 6, according to the present embodiment, as for the terminal group 8 forming the fuse block 3, a yield during a production of the terminal can be more effectively improved than in the usual fuse block. Accordingly, a cost can be effectively reduced.

Here, features of the embodiment of the above-described fuse block according to the present invention will be briefly and collectively listed in below-described [1] to [3].

[1] A fuse block 3 includes a first terminal 12 having one or a plurality of tuning fork shaped terminal parts 10 formed in one end and one or a plurality of first board connection parts (board connection parts) 11 formed in the other end and a second terminal 13 having a power input terminal part 18 formed in one end and second board connection parts 19 formed in the other end with the number corresponding to the number of the first board connection parts (the board connection parts) 11. Further, the second board connection parts 19 are inserted into through holes 17 to which the first board connection parts (the board connection parts) 11 are inserted and electrically connected together therewith.
[2] In a fuse block 3 including the structure of the above-described [1], the first board connection parts (the board connection parts) 11 and the second board connection parts 19 which are connected together are superposed one upon another and parts (vertical plate parts) 16 continuous thereto are also superposed thereon.
[3] In a fuse block 3 including the structure of the above-described [1] or [2], the first terminal 12 and the second terminal 13 are formed with metal plates made of different materials.

It is to be understood that the present invention may be changed in various ways within a range that does not change the gist of the present invention.

According to the fuse block of the present invention, the fuse block can be provided which can improve a yield during a production of a terminal, so that a cost can be reduced.

What is claimed is:

1. A fuse block comprising:
a first terminal including one or a plurality of tuning fork shaped terminal parts formed in one end and one or a plurality of first board connection parts formed in the other end; and
a second terminal including a power input terminal part formed in one end and second board connection parts formed in the other end with the number corresponding to the number of the first board connection parts,
wherein the second board connection parts are inserted into through holes to which the first board connection parts are inserted and electrically connected together therewith.

2. The fuse block as set forth in claim 1, wherein
the first board connection parts and the second board connection parts which are connected together are superposed one upon another and parts continuous thereto are also superposed thereon.

3. The fuse block as set forth in claim 1, wherein
the first terminal and the second terminal are formed with metal plates made of different materials.
